(19) United States
(12) Patent Application Publication
(10) Pub. No.: US 2011/0098145 A1
(43) Pub. Date: Apr. 28, 2011

(54) TENSION REGULATOR APPLIED TO A TIMING BELT

(75) Inventor: GUAN-REN WANG, KAOHSIUNG COUNTY (TW)

(73) Assignee: GONG SHUN TECHNOLOGY CO., LTD., KAOHSIUNG COUNTY (TW)

(21) Appl. No.: 12/772,352

(22) Filed: May 3, 2010

(30) Foreign Application Priority Data
Oct. 28, 2009 (TW) 098219919

(51) Int. Cl. F16H 7/08

(52) U.S. Cl. 474/110

(57) ABSTRACT

A tension regulator employs a first blocking member fixed between a plunger on a propelling member and the blocking device to permit a smooth sliding movement of the propelling member to be achieved via a stable support while the plunger driving the propelling member of the propelling device. Additionally, the reinforced limitation to the sliding movement of the plunger provided by the first blocking member could accordingly prevent the propelling member from an over-protruding incident. Thence, since hydraulic oil is properly blocked by the first blocking member, no leakage of the oil would adversely occur, and no air would unfavorably enter into the sliding space in time of the sliding. Thence, the tension regulator possesses a more stable operation, and a driving safety could be promoted.

### BACKGROUND OF THE INVENTION

1. Field of the Invention

The present invention relates to a tension regulator, particularly to a tension regulator applied to a timing belt.

2. Description of the Related Art

Referring to FIGS. 1 and 2, a conventional tension regulator 1 applied to a timing belt comprises a body 11, an elastic device 12 disposed in the body 11, a propelling device 13 elongated into the body 11 for being propelled by the elastic device 12, and a blocking device 14 sealing the body 11 as well as blocking the propelling device 13. Wherein, the body 11 has a sliding space 111, whose diameter is uniform and whose interior is capable of filling with hydraulic oil 15, and an opening 112 formed on the body 11 for the sliding space 111 to communicate with an exterior through the opening 112. Moreover, the propelling device 13 has a propelling member 131 elongated into the sliding space 111 as well as protruded out of the blocking device 14, a plunger 132 disposed on the propelling member 131 sliding within the sliding space 111, a controlling member 133 disposed on the plunger 132, and a limiting member 134 disposed on the sliding space 111 for limiting a sliding movement of the plunger 132. Herein, a plurality of apertures 135 are defined on the plunger 132 and controlled by the controlling member 133. As a result, an on-off function is achievable.

Referring to FIG. 2, the timing belt (not shown) is propelled by the tension regulator 1; that is, the plunger 132 is propped by the elasticity of the elastic device 12, so that the propelling member 131 protruded out of the blocking device 14 is able to thrust the timing belt with proper pressure. Afterward, the propelling member 131 would be triggered by means of the bounce of the timing belt, so that the plunger 132 would retract to engage with the elastic device 12. Accordingly, the propelling device 13 resumes the action for a next thrust, and thence promotes a regular operation of the timing belt.

However, the conventional tension regulator 1 has the following shortcomings:

1. When the replenishment of the hydraulic oil 15 to the conventional tension regulator 1 is artificially sealed with the blocking device 14, air in the sliding space 111 could not be entirely exhausted; namely, the air still exists in the body 11. As a result, while the plunger 132 slides in the sliding space 111, the air would mingle with the flowed hydraulic oil 15, which incurs the air to pervade the sliding space 111. Whereby, since the air is contractible, an incomplete operation of the tension regulator would be unfavorably resulted, thereby adversely incurring an unsafe driving.

Furthermore, in view of the artificial filling of the hydraulic oil 15, the filling amount of the hydraulic oil 15 is subject to change. That is, the filling quantity of the hydraulic oil 15 would readily affect the air amount contained in the body 11. However, the more the air is contained in the sliding space 111, the less the hydraulic oil 15 would be adversely filled, and a stable motion of the plunger 132 is accordingly inaccessible. As a result, the hydraulic oil 15 mixed with air would readily influence the stability of the tension regulator 1.

2. In fact, during the operation, the propelling member 131 is merely supported by the plunger 132 and the blocking device 14. However, since the blocking device 14 is made of rubber, which has a softer characteristic, an unstable support is easily caused in time of stretching or contracting the propelling member 131. As a result, the propelling member 131 likely becomes slanted. Thereby, the protruding distance of the propelling member 131 is probably varied, and the car is possibly damaged because of the imperfect push from the propelling member 131 on the timing belt.

3. The plunger 132 is only restricted by the limiting member 134 for attaining an engagement with the body 11. Herein, because the abovementioned installation is artificial or due to the fact that the propelling of the slanted propelling member 131 with the plunger 132 adversely incurs a burden on the limiting member 134, the plunger 132 is unable to be properly engaged with the limiting member 134. Thus, the plunger 132 unavoidably protrudes beyond the limiting member 134, and the propelling member 131 improperly projects from the body 11. As a result, the propelling device 13 is unable to offer a precise thrust impinged on the timing belt, and the driving safety is influenced.

### SUMMARY OF THE INVENTION

The object of the present invention is to provide a tension regulator applied to a timing belt, which provides a firm support for a propelling member to avoid an over-protruding incident and preferably prevents hydraulic oil from leaking out in view of any undue pressure; whereby, a stable operation of the present invention could be achieved to promote the driving safety.

The tension regulator applied to a timing belt in accordance with the present invention comprises a body, an elastic device disposed in the body, a propelling device elongated into the body as well as propelled by the elastic device, and a blocking device sealing the body as well as blocking the propelling device. Wherein, a first blocking member is fixed between a plunger of the propelling device and the blocking device for giving a synchronous support, thereby permitting a smooth sliding movement of the propelling device while the plunger drives the propelling member to displace. Furthermore, the arrangement of the blocking member substantially leads to air unable to penetrate into the body during the sliding of the plunger, and the hydraulic oil flowing along with the sliding plunger would not scatter to impact the blocking member. As a result, the hydraulic oil would not readily leak out. In addition, since the first blocking member could reinforce the limitation to the sliding movement of the plunger, the propelling member could be accordingly prevented from an over-protruding incident. Thence, the tension regulator preferably facilitates a stable operation and efficiently promotes a driving safety.

In this connection, the tension regulator applied to a timing belt as claimed comprises a body, an elastic device disposed in the body, a propelling device disposed in the body for being propelled by the elastic device, and a blocking device sealing the body for blocking the propelling device; wherein, a sliding space being defined in the body for accommodating hydraulic oil, and an opening being defined on the body for the sliding space to communicate with an exterior; the propelling device including a propelling member elongated into the sliding space and protruded out of the blocking device, a plunger connected to the propelling member and allowed sliding within the sliding space, a controlling member installed on the plunger, and a limiting member mounted on the sliding space for limiting a sliding movement of the plunger; a plurality of apertures being defined on the plunger, and an on & off function of the apertures being controlled by the controlling member;

wherein, a first blocking member being disposed between a plunger and the blocking device as well as engaged with the sliding space; a sliding movement of the propelling member brought about by the plunger would not affect the first blocking member, so that a stable support would be provided to prop up the sliding movement of the propelling member and the hydraulic oil would be prevented from scattering in time of the plunger being moved.

Preferably, the first blocking member is grasped by a fastener for fixing on the sliding space.

Preferably, a second blocking member is disposed on the body and clasped by a fastener for fixing on the sliding space; the second blocking member includes a blocking wall, and an accommodating room encompassed by the blocking wall.

Preferably, the sliding space includes a first area and a second area intercommunicated with the first area as well as disposed near to the opening; the first area has a diameter smaller than a diameter of the second area.

The advantages of the present invention over the known prior arts will become more apparent to those of ordinary skilled in the art upon reading the following descriptions in junction with the accompanying drawings.

### BRIEF DESCRIPTION OF THE DRAWINGS

FIG. 1 is a schematic view showing a conventional tension regulator;

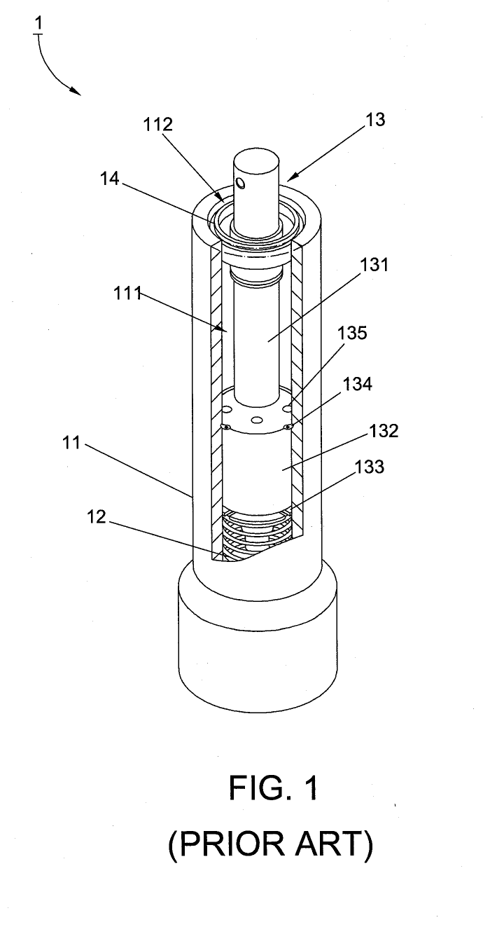

FIG. 2 is a schematic view showing the conventional tension regulator in using;

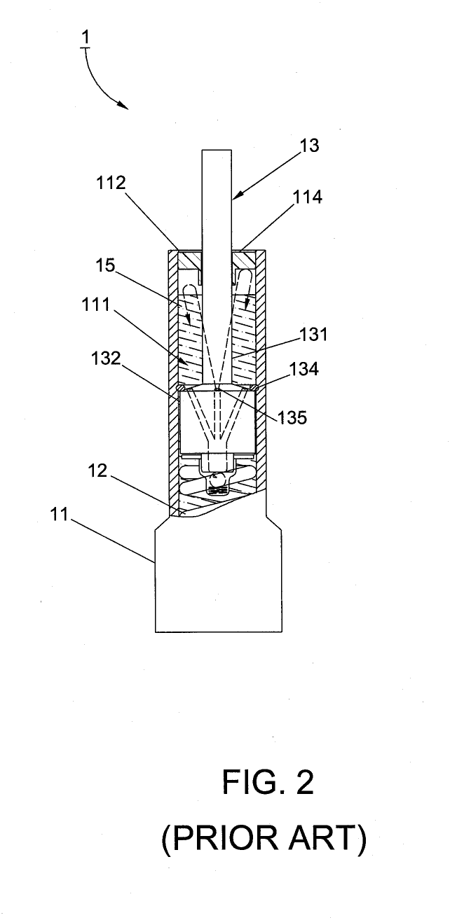

FIG. 3 is a perspective view showing a first preferred embodiment of the present invention;

FIG. 4 is schematic view showing the first preferred embodiment in using;

FIG. 5 is another schematic view showing the first preferred embodiment in using;

FIG. 6 is a schematic view showing a second preferred embodiment of the present invention;

FIG. 7 is a schematic view showing a third preferred embodiment of the present invention; and

FIG. 8 is a schematic view showing a fourth preferred embodiment of the present invention.

### DETAILED DESCRIPTION OF THE PREFERRED EMBODIMENTS

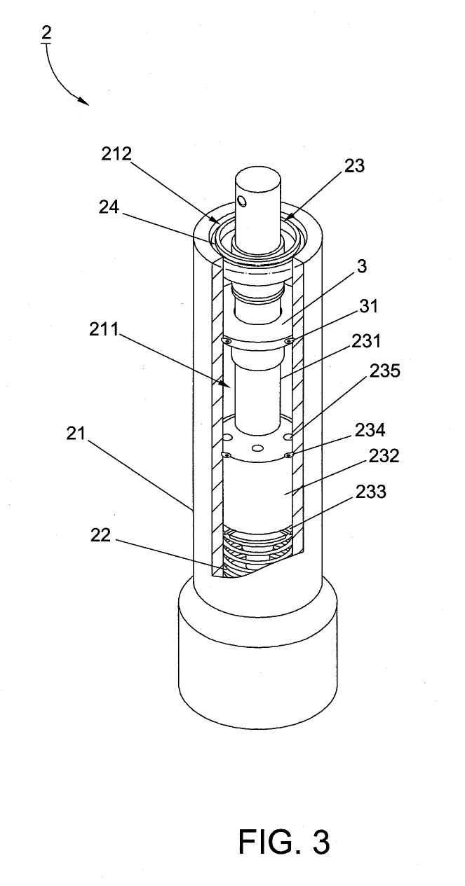

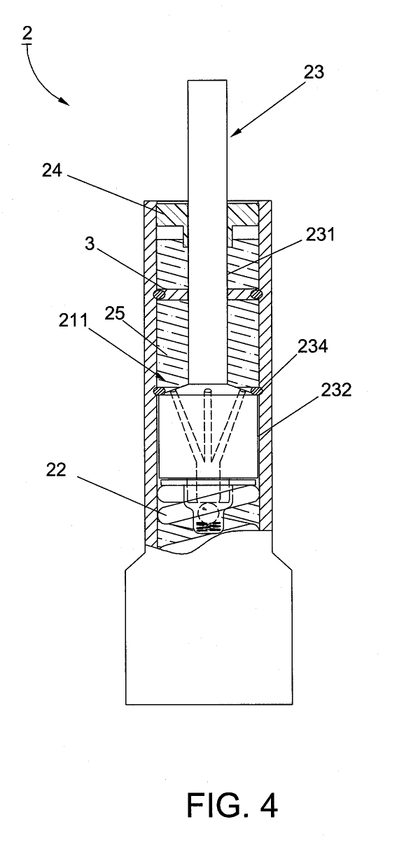

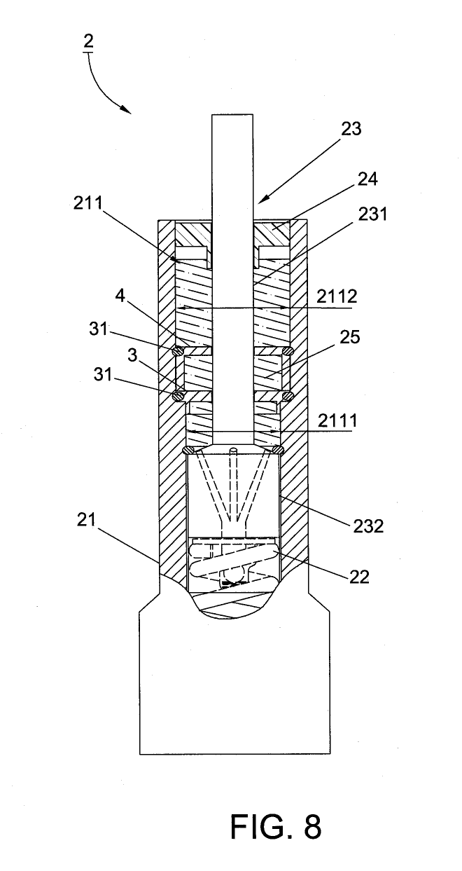

FIG. 3 shows a first preferred embodiment of the present invention, a tension regulator 2 adapted for a timing belt comprising a body 21, an elastic device 22 disposed in the body 21, a propelling device 23 disposed in the body 21 as well as propelled by the elastic device 22, and a blocking device 24 sealing the body 21 and blocking the propelling device 23. Wherein, a sliding space 211 is formed inside the body 21 for being filled with hydraulic oil 25 (shown in FIG. 4). Concurrently, an opening 212 is defined on the body 21 for the sliding space 211 to communicate with the exterior thereby. The propelling device 23 includes a propelling member 231 elongated into the sliding space 211 as well as protruded out of the blocking device 24, a plunger 232 disposed on the propelling member 231 for sliding inside the sliding space, a controlling member 233 disposed on the plunger 232, and a limiting member 234 disposed on the sliding space 211 for limiting a sliding movement of the plunger 232. Herein, the plunger 232 could be alternatively formed by a longer structure for wrapping the elastic device 22 as shown in FIG. 8; the following embodiments mainly depict the plunger 232 structured by a shorter contour so as to engaging with the elastic device 22 as shown from FIGS. 3 to 7. Further, a plurality of apertures 235 are defined on the plunger 232 as well as controlled by the controlling member 233 so as to accomplish an on-off function. Herein, a first blocking member 3 is disposed between the plunger 232 and the blocking device 24 as well as fixed to the sliding space 211; the first blocking member 3 is substantially grasped by a fastener 31 as an example in this embodiment.

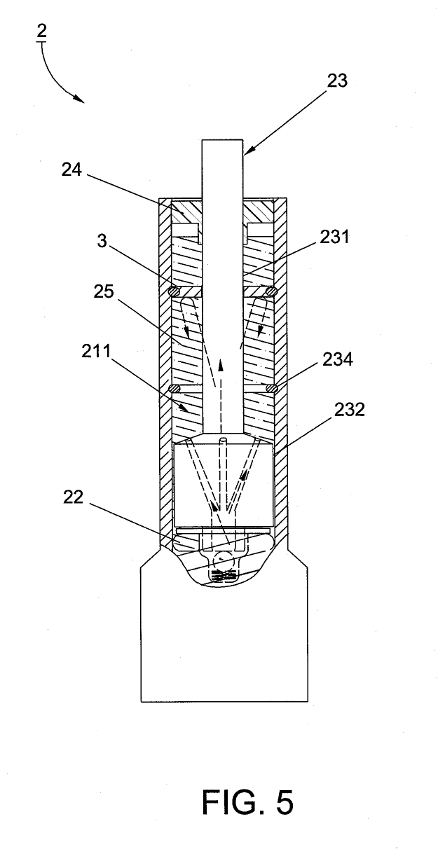

Referring to FIGS. 4 and 5, the timing belt (not shown) is engaged with the tension regulator 2; namely, the plunger 232 slides by means of the elastic device 22 providing with the elasticity to push the propelling member 231 toward the timing belt. Accordingly, the timing belt could be properly operated via the related propelling device 23. Herein, concerning to the manner that the first blocking member 3 is disposed between the plunger 232 and the blocking device 24, the sliding movement of the plunger 232 could be not only limited by the limiting member 234 but also stably supported by the first blocking member 3 when the propelling member 231 driven by the plunger 232 protrudes outward. Hereby, the first blocking member 3 does not move along with the propelling member 231, so that the propelling member 231 could be prevented from being slanted while propelling the timing belt. Consequently, the timing belt could be well thrust. Afterward, the propelling member 231 would retract via the bounce provided by the timing belt so as to allow the plunger 232 to resume. Thereby, the propelling device 23 is able to execute its propelling again. Perceptibly, the operating stability of the tension regulator 2 applied to the timing belt is promoted to increase the driving safety.

In fact, as long as the plunger 232 is moved, the hydraulic oil 25 would be subjected to a compulsive pressure, and such pressure would allow the hydraulic oil 25 to scatter. Hereby, in view of the disposition of the first blocking member 3, the scattered hydraulic oil 25 would be blocked for not directly impacting the blocking device 24 during the pressing. As a result, the hydraulic oil 25 would not readily seep out of the blocking device 24. Moreover, the first blocking member 3 is also able to obstruct the air staying inside the sliding space 211 for preventing the hydraulic oil 25 from flowing along with air mingled therewith. Accordingly, the operation related to the invention could be assured to be stable. By the stable support provided by the first blocking member 3, the plunger 232 driving the protrusion of the propelling member 231 would not slant aside, and the protruding distance out of the body 21 would not vary. In addition, even if the filling of the hydraulic oil 25 into the sliding space 211 is artificially operated, of which the amount is subjectively replenished, the location of the first blocking member 3 could be deemed as a filling extreme. That is, users continue filling the sliding space 211 with the hydraulic oil 25 until the oil level reaches the first blocking member 3 indicative of the filling extreme, so that an adequate replenishment of the hydraulic oil 25 could be preferably guaranteed without over-filling or insufficiency, and the reciprocating operation of the propelling device 23 is steady. Therefore, the tension regulator 2 applied to the timing belt possesses a stable action to promote the driving safety.

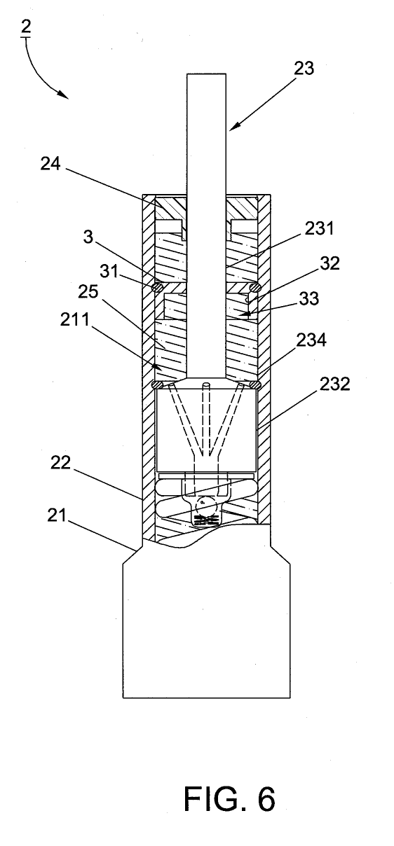

FIG. 6 shows a second preferred embodiment of the present invention. The tension regulator 2 applied to the timing belt is similar to that of the first preferred embodiment. In this embodiment, the tension regulator 2 similarly comprises a body 21, an elastic device 22, a propelling device 23 and a blocking device 24. Wherein, the disposing manner of the first blocking member 3 on the body 21 is similarly to be firmly grasped by the fastener 31 for being fixed on the sliding space 211. Differently, the first blocking member 3 further includes a first wall 32, and a receiving room 33 encompassed by the first wall 32, thereby permitting the first blocking member 3 to be formed like a cup. As a result, no matter the first blocking member 3 is formed as that depicted in the FIG. 5 or in the FIG. 6, the first blocking member 3 is able to obstruct the leakage of the hydraulic oil 25 and prevent the oil from scattering in time of the pressing. Besides the function as mentioned above, the first blocking member 3 is able to preferably obstruct the entry of air, and the hydraulic oil 25 could steadily stay in the receiving room 33, so that sufficient hydraulic oil 25 could be assured to conduce to a smooth sliding movement of the plunger 232, and the propelling member 231 could be also accordingly driven and projected with stability.

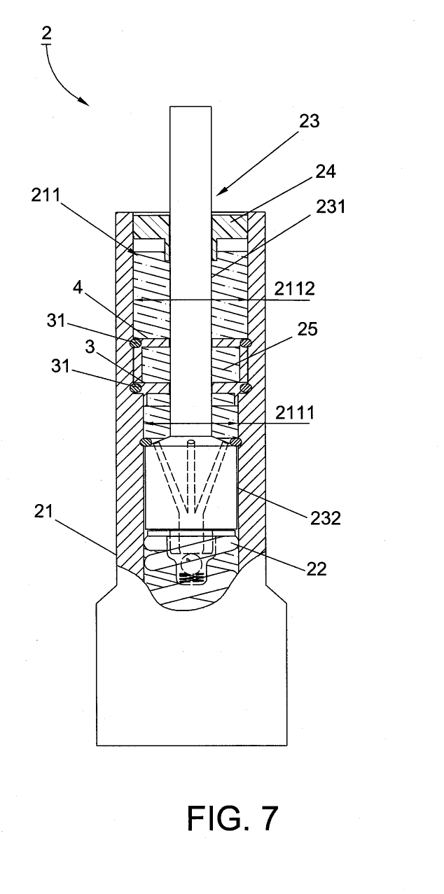

FIG. 7 shows a third preferred embodiment of the present invention. The tension regulator 2 applied to the timing belt comprises comparable elements similar to those in the first embodiment like the body 21, the elastic device 22, the propelling device 23, the blocking device 24 and the first blocking member 3. Differently, in this embodiment the sliding space 211 of the body 21 includes a first area 2111 and a second area 2112 communicated with the first area 2111 as well as disposed near the opening 212. Further, a second blocking member 4 disposed on the body 21 is firmly grasped by the fastener 31 for fixing to the sliding space 211. Moreover, the second blocking member 4 has a blocking wall 41, and an accommodating room 42 encompassed by the blocking wall 41, thereby allowing the second blocking member 4 to be formed like a cup. Accordingly, the second blocking member 4 is superimposed on the first blocking member 3 as shown in the Figure. Wherein, the first area 2111 has a diameter smaller than a diameter of the second area 2112. Further, the elastic device 22 could be installed at the first area 2111, and both the first blocking member 3 and the second blocking member 4 firmly grasped by the fastener 31 are respectively located within the first area 2111 and the second area 2112. Therefore, the propelling member 231 is able to be well supported by the both first and second blocking members 3, 4 to achieve a more stable propelling action without slanting and lead to a more steady thrust from the tension regulator 2 to the timing belt. Accompanying with the dual obstruction provided from the first and the second blocking members 3, 4, it is able to favorably impede scattering the hydraulic oil 25 throughout. It also substantially prevents the entry of the air in the sliding space 211 and the inappropriate protrusion of the propelling member 231.

To sum up, the present invention takes advantage of the first blocking member disposed between the plunger and the blocking member inside the sliding space for effectively limiting the sliding movement of the plunger as well as preventing the propelling member from over-protruding. As a result, the hydraulic oil could be obstructed for not impacting the blocking device to avoid a leakage. Therefore, no air would enter into the sliding space while the plunger is moved, and the operating action could be assured to be precise. Thus, in view of the stable operation provided by the tension regulator of the present invention, the driving safety could be preferably promoted.

While we have shown and described the embodiment in accordance with the present invention, it should be clear to those skilled in the art that further embodiments may be made without departing from the scope of the present invention.

What is claimed is:

1. A tension regulator applied to timing belt comprising a body, an elastic device disposed in said body, a propelling device disposed in said body for being propelled by said elastic device, and a blocking device sealing said body for blocking said propelling device; wherein, a sliding space being defined in said body for accommodating hydraulic oil, and an opening being defined on said body for said sliding space to communicate with an exterior; said propelling device including a propelling member elongated into said sliding space and protruded out of said blocking device, a plunger connected to said propelling member and allowed sliding within said sliding space, a controlling member installed on said plunger, and a limiting member mounted on said sliding space for limiting a sliding movement of said plunger; a plurality of apertures being defined on said plunger, and an on & off function of said apertures being controlled by said controlling member;
wherein, a first blocking member being disposed between said plunger and said blocking device as well as engaged with said sliding space; a sliding movement of said propelling member brought about by said plunger would not affect said first blocking member, so that a stable support would be provided to prop up said sliding movement of said propelling member.

2. The tension regulator as claimed in claim 1, wherein said first blocking member is grasped by a fastener for fixing on said sliding space.

3. The tension regulator as claimed in claim 1, wherein, a second blocking member is disposed on said body and clasped by a fastener for fixing on said sliding space; said second blocking member includes a blocking wall, and an accommodating room encompassed by said blocking wall.

4. The tension regulator as claimed in claim 1, wherein, said sliding space includes a first area and a second area intercommunicated with said first area as well as disposed near to said opening; said first area has a diameter smaller than a diameter of said second area.

5. The tension regulator as claimed in claim 1, wherein, said first blocking member is extensively formed with a first wall, and a receiving wall encompassed by said first wall; the sliding movement of said propelling member brought about by the plunger would not allow a synchronic movement on said first blocking member.
